(19) United States
(12) Patent Application Publication
(10) Pub. No.: US 2026/0119526 A1
(43) Pub. Date: Apr. 30, 2026

(54) TABLE DATA PROCESSING METHOD, DEVICE AND MEDIUM

(71) Applicant: Beijing Zitiao Network Technology Co., Ltd., Beijing (CN)

(72) Inventor: Xupan LI, Beijing (CN)

(21) Appl. No.: 19/370,484

(22) Filed: Oct. 27, 2025

(30) Foreign Application Priority Data
Oct. 30, 2024 (CN) 202411535304.8

(51) Int. Cl. G06F 16/26; G06F 11/14; G06F 16/23

(52) U.S. Cl. CPC G06F 16/26; G06F 11/1451; G06F 16/2358

(57) ABSTRACT

A table data processing method, an electronic device, and a storage medium are provided. The method includes: receiving, by a client, a data viewing request for a target table, and determining a first editing time corresponding to first table data to be requested to view, wherein the client stores second table data corresponding to the target table at a second editing time; determining, according to the first editing time and the second editing time, data to be altered corresponding to the data viewing request in the second table data in response to the first editing time being later than the second editing time; and backing up the data to be altered, and displaying the first table data in the client according to the second table data and the data to be altered that has been backed up.

### CROSS-REFERNCE TO RELATED APPLICATION

This application claims priority to Chinese Patent Application No. 202411535304.8, filed on October 30, 2024, the entire disclosure of which is incorporated herein by reference as part of the present disclosure.

### TECHNICAL FIELD

Embodiments of the present disclosure relate to the field of computer processing technology, and in particular, to a table data processing method and a device, and a medium.

### BACKGROUND

With the rapid development of Internet office, analytical processing and collection of data have become extremely important, and the application of tables have become increasingly wide. A user can store and manage data through a table, and can view historical table data resulted from the edition of the table at any historical moment.

In the related art, each time when the user views the corresponding historical table data of the table at any historical moment, it is necessary to pull, from a server, the historical table data corresponding to the corresponding historical moment, and cache the pulled historical table data to a client for displaying. However, such a table data processing manner may result in slow response of the client to a table viewing request, and a lot of resource storage space of the client may be occupied, which brings great pressure for the internal memory of the client and affects the use experience of the user on the table.

### SUMMARY

The present disclosure provides a table data processing method, a device, and a medium.

The present disclosure provides a table data processing method, comprising: receiving, by a client, a data viewing request for a target table, and determining a first editing time corresponding to first table data to be requested to view, wherein the client stores second table data corresponding to the target table at a second editing time; determining, according to the first editing time and the second editing time, data to be altered corresponding to the data viewing request in the second table data in response to the first editing time being later than the second editing time; and backing up the data to be altered, and displaying the first table data in the client according to the second table data and the data to be altered that has been backed up.

In at least one embodiment, the determining, according to the first editing time and the second editing time, data to be altered in the second table data comprises: determining a data editing operation to alter the second table data to the first table data according to the first editing time and the second editing time, and obtaining table data associated with the data editing operation in the second table data as the data to be altered.

In at least one embodiment, the determining a data editing operation to alter the second table data to the first table data according to the first editing time and the second editing time comprises: determining a first data alteration identifier corresponding to the first editing time and a second data alteration identifier between the first editing time and the second editing time, and obtaining the data editing operation performed on table data corresponding to the first data alteration identifier and the second data alteration identifier.

In at least one embodiment, the data to be altered comprises at least table data to be altered and location data of the table data to be altered in the target table.

In at least one embodiment, the displaying the first table data in the client according to the second table data and the data to be altered that has been backed up comprises: performing the data editing operation on the data to be altered that has been backed up to generate target altered data, and displaying the first table data in the client according to the second table data and the target altered data.

In at least one embodiment, the displaying the first table data in the client according to the second table data and the target altered data comprises: determining unaltered table data other than the data to be altered in the second table data, and displaying the first table data in the client according to the unaltered table data and the target altered data.

In at least one embodiment, after determining the first editing time of the target table corresponding to the first table data to be requested to view, the method further comprises: pulling, from a server, third table data corresponding to the target table at the first editing time and storing the third table data to the client in response to the first editing time being earlier than the second editing time; and displaying, based on the third table data stored by the client, the first table data corresponding to the data viewing request in the client.

In at least one embodiment, the method further comprises: after displaying the second table data or the first table data of the target table at the second editing time in the client, in response to the target table being a first subtable in a database table and the database table comprising a second subtable, receiving, by the client, a subtable switching operation on the second subtable, and displaying, according to the second table data, fourth table data of the second subtable at the second editing time.

In at least one embodiment, after displaying the first table data in the client according to the second table data and the data to be altered that has been backed up, the method further comprises: highlighting, in the first table data, target table data generated by editing the target table at the first editing time.

Embodiments of the present disclosure further provide an electronic device comprising: one or more processors; and a storage apparatus configured to store one or more programs, and the one or more programs, when executed by the one or more processors, cause the one or more processors to implement the above table data processing method according to any one embodiment.

Embodiments of the present disclosure further provide a non-transitory computer-readable storage medium, storing a computer program which, when executed by a processor, causes the above table data processing method according to any one embodiment to be implemented.

### BRIEF DESCRIPTION OF DRAWINGS

The above and other features, advantages and aspects of different embodiments of the present disclosure will become more apparent from the accompanying drawings and the following specific embodiments. Identical or similar reference numerals indicate identical or similar elements throughout the drawings. It will be understood that the drawings are illustrative, and components and elements are not necessarily drawn to scale.

FIG. 1 is a flowchart of a table data processing method provided by an embodiment of the present disclosure;

FIG. 2 is a timing flowchart of a table data processing method provided by an embodiment of the present disclosure;

FIG. 3 is a flowchart of another table data processing method provided by an embodiment of the present disclosure;

FIG. 4 is a schematic diagram of a table data displaying process provided by an embodiment of the present disclosure;

FIG. 5 is a flowchart of another table data processing method provided by an embodiment of the present disclosure;

FIG. 6 is a flowchart of another table data processing method provided by an embodiment of the present disclosure;

FIG. 7 is a schematic diagram of an interface for displaying a database table provided by an embodiment of the present disclosure;

FIG. 8 is a structural schematic diagram of a table data processing apparatus provided by an embodiment of the present disclosure; and

FIG. 9 is a structural schematic diagram of an electronic device provided by an embodiment of the present disclosure for implementing the embodiments of the present disclosure.

### DETAILED DESCRIPTION

Embodiments of the present disclosure will be described below in more detail with reference to the accompanying drawings. While the accompanying drawings show some embodiments of the present disclosure, it will be understood that the present disclosure may be implemented in various forms and should not be construed as being limited to the embodiments set forth herein. Rather, these embodiments are provided so that the present disclosure can be understood more thoroughly and comprehensively. It should be understood that the accompanying drawings and the embodiments of the present disclosure are only used as examples, and are not intended to limit the protection scope of the present disclosure.

It will be understood that steps described in the method implementations of the present disclosure may be performed in different orders and/or concurrently. In addition, the method implementations may include additional steps and/or the steps shown may be omitted. The scope of the present disclosure is not limited in this aspect.

As used herein, the term “include” and variants thereof are open words and should be construed as “including but not limited to”. The term “based on” means “at least in part based on”. The term “one embodiment” represents “at least one embodiment”; the term “another embodiment” represents “at least one further embodiment”; and the term “some embodiments” represents “at least some embodiments”. The relevant definitions of other terms will be given in the following descriptions.

It needs to be noted that terms such as "first" and "second" are used for distinguishing between different apparatuses, modules or units rather than defining the sequence or interdependent relation of functions performed by such apparatuses, modules or units.

It needs to be noted that terms such as “a/an” and “a plurality of” used herein are illustrative and non-limiting. It will be understood by a person skilled in the art that “a/an” shall be construed as “one or more” unless specified otherwise.

Names of messages or information exchanged between a plurality of apparatuses in embodiments of the present disclosure are only used for the purpose of description and not meant to limit the scope of these messages or information.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user.

For example, in response to receiving an active request from a user, prompt information is sent to the user to explicitly prompt the user that the operation the user requests to perform will require to acquire and use the personal information of the user. Thus, the use can independently select, according to the prompt information, whether or not to provide the personal information to software or hardware such as an electronic device, an application, a server or a storage medium that performs the operations of the technical solutions of the present disclosure.

As an alternative but non-limiting implementation, in response to receiving an active request from a user, a manner of sending a prompt information to the user may be, for example, using a pop-up window in which the prompt information may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

It will be understood that data (including but not limited to data itself, and the acquisition and use of data) involved in the present technical solutions should follow corresponding laws and regulations and requirements of relevant stipulations.

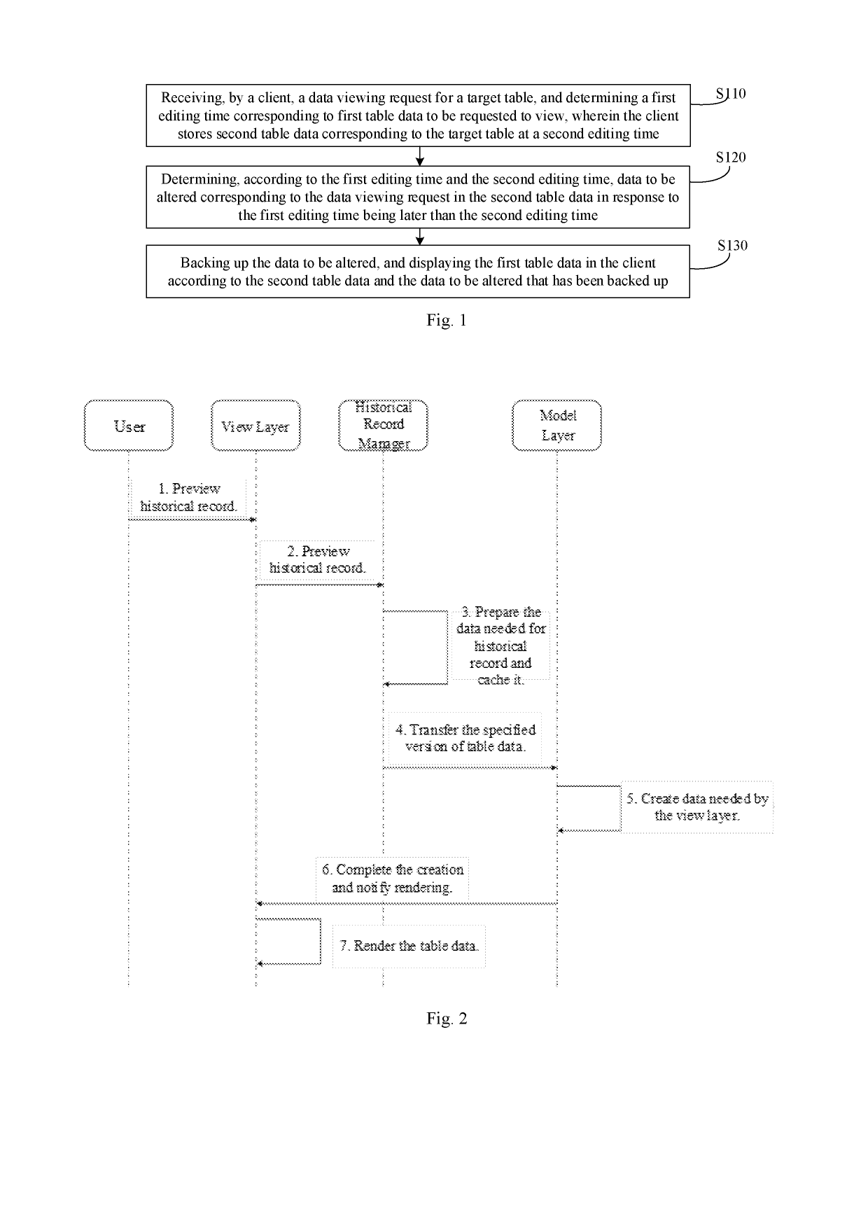

FIG. 1 is flowchart of a table data processing method provided by an embodiment of the present disclosure. This embodiment of the present disclosure is applicable to the scenario where the corresponding historically edited table data of a target table is viewed by a client. This method may be performed by a table data processing apparatus which may be implemented in the form of software and/or hardware and optionally implemented by an electronic device. The electronic device may be a mobile terminal, a personal computer (PC), a server, or the like.

As shown in FIG. 1, the method of this embodiment of the present disclosure may include the following steps.

S110: receiving, by a client, a data viewing request for a target table, and determining a first editing time corresponding to first table data to be requested to view, wherein the client stores second table data corresponding to the target table at a second editing time.

The target table may be a table supporting viewing of data associated with the table. The target table may be any type of table. Optionally, the target table is an independent table or a subtable in a table accessed. The data viewing request may be construed as an instruction for requesting to perform the operation of viewing the table data. The data viewing request may be generated in a plurality of ways. Optionally, the data viewing request may be generated in response to detecting a triggering operation on a preset data viewing control; or, the data viewing request may be generated in response to detecting that the received audio information includes a trigger word associated with the viewed data; or, the data viewing request may be generated in response to receiving a data viewing triggering instruction input by a user. The first table data may be a historical table editing record corresponding to the target table. In other words, the first table data may be data obtained by editing the target table at a historical time. In an embodiment of the present disclosure, after the target table has been created, the data in the target table may also be edited again. The table data obtained after the completion of editing each time may be used as the table data corresponding to the target table, and the table data obtained by editing and the corresponding editing time thereof may be stored in association with each other. Further, the historically edited table data may also be viewed, and the historically edited table data to be requested to view may be used as the first table data. The first editing time may be the time of obtaining, by editing, the first table data. The second table data may be data obtained after editing the target table at a historical time and stored in the client. The second table data may be table data pulled by the client from a server and corresponding to the target table at the second editing time. The second editing time may be the time of obtaining, by editing, the second table data. In an embodiment of the present disclosure, the first editing time and the second editing time may be adjacent two historical editing times, or may be nonadjacent two historical editing times.

As a possible implementation of the present disclosure, the first table is a database table. Each column of the database table has a fixed field type, and a content filled in a cell in each column is required to correspond to the field type of this column. In other words, the field type may be used for defining at least one of information such as a data format, a data type, and a data content of data filled in the cells of the column. Exemplarily, the field type may include, but is not limited to, one or more of types such as a text type, an option type, a date type, and a numeric type.

It needs to be noted that the second table data stored in the client may be the second table data corresponding to the target table at the second editing time pulled from the server when the second editing time is determined randomly, and the pulled second table data is stored in the client. Alternatively, when the data viewing request for the second table data of the target table at the second editing time is received by the client, the second table data may be pulled from the server and stored in the client.

In an embodiment of the present disclosure, the second table data associated with the target table at the second editing time may be pulled by the client from the server and stored in the client. Further, a plurality of pieces of table data corresponding to the target table may be shown based on a display interface of the client. Further, the first table data to be requested to view may be determined and the first editing time corresponding to the first table data may be determined in response to receiving the data viewing request for any table data corresponding to the target table by the client,.

S120: determining, according to the first editing time and the second editing time, data to be altered corresponding to the data viewing request in the second table data in response to the first editing time being later than the second editing time.

The data to be altered may be table data to be edited in the second table data as compared with the first table data. In an embodiment of the present disclosure, when the first editing time is later than the second editing time, the first table data can be obtained only after a data editing operation is input on the basis of the second table data, and the data in the second table data that is edited to obtain the first table data may be used as the data to be altered. The data to be altered may be data associated with the data editing operation. Optionally, when the data editing operation of altering from the second table data to the first table data is a data adding operation, the data to be altered may be data not existing in the second table data as compared with the first table data; or, when the data editing operation of altering from the second table data to the first table data is a data deleting operation, the data to be altered may be data redundant in the second table data as compared with the first table data; or, when the data editing operation of altering from the second table data to the first table data is a data modifying operation, the data to be altered may be data to be modified in the second table data as compared with the first table data, or the like.

In practical application, when the data viewing request for the first table data corresponding to the first editing time is received by the client and the editing time corresponding to the table data stored in the client is earlier than the first editing time, typically, the first table data corresponding to the first editing time is directly pulled by the client from the server, and the pulled first table data is displayed and stored. This data viewing way may occupy a lot of resource storage space of the client and in turn affects the request response efficiency of the client.

In view of this, in an embodiment of the present disclosure, when the first editing time corresponding to the first table data to be requested to view is determined, the first editing time may be compared with the second editing time corresponding to the second table data stored in the client. Further, when the first editing time is later than the second editing time, the table data to be edited in the second table data as compared with the first table data may be determined according to the first editing time and the second editing time. Thus, the determined table data may be used as the data to be altered corresponding to the data viewing request in the second table data. Thus, the first table data may be determined according to the data to be altered and the second table data. Accordingly, the effect of determining the table data to be requested to view in accordance with the table data stored in the client may be achieved, thus improving the request response efficiency and the data viewing efficiency.

As an optional implementation of the embodiments of the present disclosure, both of the first table data and the second table data are table data obtained after editing based on the data editing operation, and when the first editing time is later than the second editing time, the first table data may be the table data obtained after inputting the data editing operation on the basis of the second table data. Thus, when it is determined that the first editing time is later than the second editing time, the data editing operation to be performed as required by altering from the second table data to the first table data may be determined according to the first editing time and the second editing time. Further, the data associated with the data editing operation in the second table data may be determined, and the data may be used as the data to be altered.

S130: backing up the data to be altered, and displaying the first table data in the client according to the second table data and the data to be altered that has been backed up.

In an embodiment of the present disclosure, when the data to be altered is determined, the data to be altered may be backed up. Further, the backed-up data to be altered may be processed. Thus, the first table data may be determined according to the altered data obtained after processing and the second table data and displayed in the client.

In practical application, when there is a need to edit the table data stored in the client to obtain the table data to be requested to view, the stored table data is typically backed up in its entirety. Further, the backed-up table data is edited to obtain the table data to be requested to view. Such a data viewing way may occupy a lot of resource storage space of the client and bring great pressure for the internal memory and the performance of the client.

In view of this, in an embodiment of the present disclosure, the data to be altered corresponding to the data viewing request in the second table data stored in the client can be determined. Further, the data to be altered is backed up, and the first table data to be requested to view is determined according to the second table data and the backed-up data to be altered. Thus, compared with backing up the stored table data in its entirety, backing up only the table data needing to be altered may effectively save the resource occupation space of the client, thus improving the request response efficiency of the client.

As an optional implementation of the embodiments of the present disclosure, after the data to be altered is backed up, the data editing operation can be performed on the backed-up data to be altered to obtain the target altered data. Further, other table data than the data to be altered in the second table data can be determined. Thus, table data can be created based on the target altered data and the other table data, and the created table data can be used as the first table data which is then displayed in the client.

In an embodiment of the present disclosure, the first table data is the table data obtained after editing the target table at the first editing time. Thus, when the first table data is displayed, in order that the user can rapidly capture, based on the displayed first table data, the data resulted from editing the target table at the first editing time, the method can optionally comprise: after displaying the first table data in the client according to the second table data and the backed-up data to be altered, highlighting, in the first table data, target table data generated by editing the target table at the first editing time.

The target table data may be the table data in the first table data that is generated by editing at the first editing time. The target table data may be at least part of table data in the first table data.

As an optional implementation of the embodiments of the present disclosure, the target table data generated by editing the target table at the first editing time can be determined according to the first editing time. Further, when the first table data is displayed on the client, the determined target table data can be highlighted in the first table data.

Exemplarily, FIG. 2 is a timing flowchart of a table data processing method provided by an embodiment of the present disclosure. As shown in FIG. 2, when the user inputs, through a view layer of the client, a historical record preview operation on the target table, historically edited table data required by preview can be pulled from a historical record manager of the server and cached in the client. Further, the cached historically edited table data can be transferred to a model layer (configured to at least process the data displayed by the view layer of the client) to create data needed by the view layer based on the model layer. Further, after the completion of creation, the created table rendering data can be transferred to the view layer, and the view layer can be notified to start rendering, and then the table data obtained by rendering is displayed based on the view layer.

According to the technical solutions of the embodiments of the present disclosure, the data viewing request for the target table is received by the client, and the first editing time corresponding to the first table data to be requested to view is determined. By means of interactive operations between the user and the client, viewing of the table data can be triggered and the subsequent operation determined for the table data can be performed. The client stores the second table data corresponding to the target table at the second editing time. The effects of storing at least part of table data corresponding to the target table is stored in the client and using the stored table data as data basis of the subsequent operation are achieved. Further, when the first editing time is later than the second editing time, the data to be altered corresponding to the data viewing request in the second table data is determined according to the first editing time and the second editing time. The effect of using the stored table data as data creation basis of the table data to be requested to view when the editing time to be requested to view is later than the stored editing time is achieved. Further, the data to be altered is backed up, and the first table data is displayed in the client according to the second table data and the backed-up data to be altered. The problems of the table data processing way in the related art, i.e., occupying a lot of resource storage space of the client and bringing great pressure for the internal memory of the client which in turns lead to slow response of the client to the table viewing request, are solved. By backing up the data to be altered in the stored table data to create the table data to be requested to view, the effect of creating the table data to be requested to view in accordance with the stored table data is achieved. Thus, the effect of effectively saving the resource occupation space of the client on the basis of ensuring that the modified stored data does not affect the cache of the client is achieved. Thus, the response rate of viewing the table data by the client is increased, and the processing performance of the client for the table data is improved.

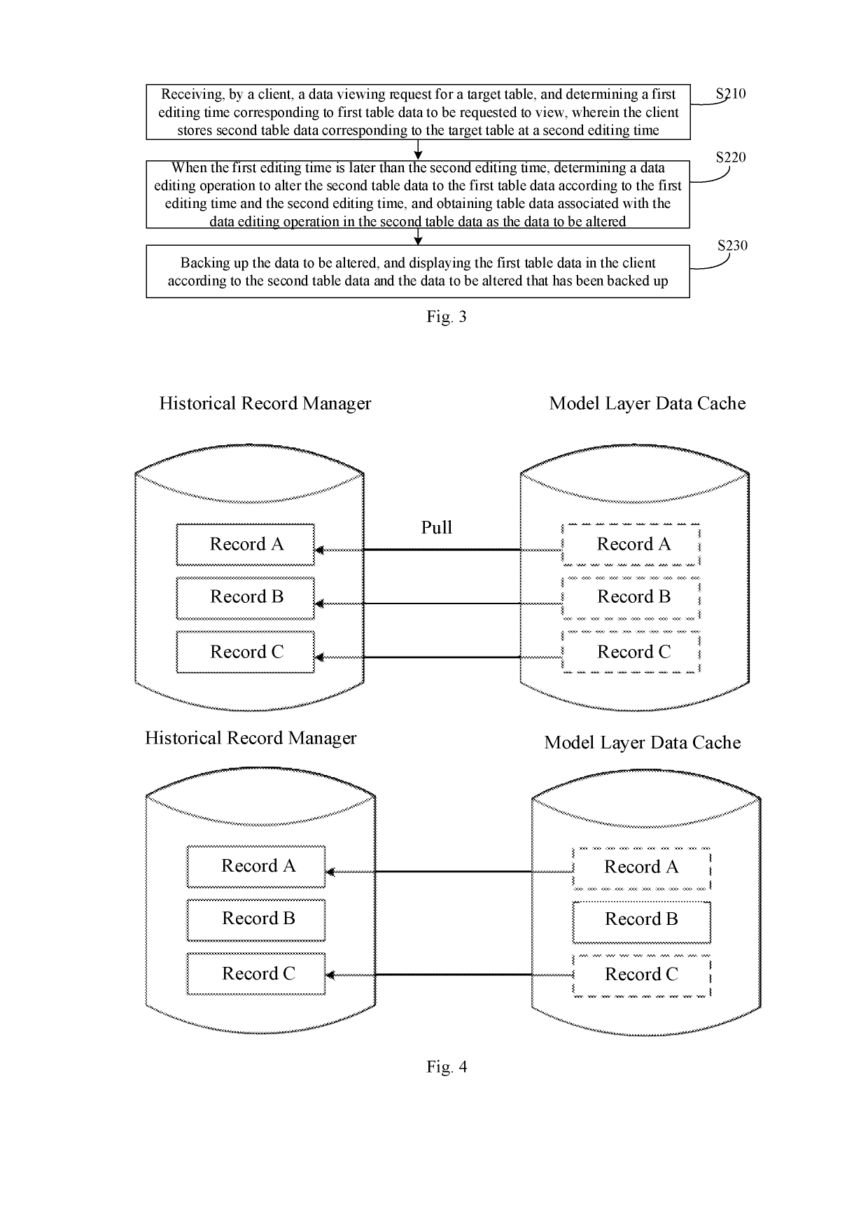

FIG. 3 is a flowchart of another table data processing method provided by an embodiment of the present disclosure. The technical solution of this embodiment of the present disclosure is to explain in detail the way of determining the data to be altered according to the first editing time and the second editing time. Optionally, determining, according to the first editing time and the second editing time, data to be altered in the second table data includes: determining, according to the first editing time and the second editing time, a data editing operation performed to alter the second table data to the first table data, and obtaining table data associated with the data editing operation in the second table data as the data to be altered. The specific implementation may be as described as in this embodiment of the present embodiment. The technical features identical or similar to those in the foregoing embodiments will not be repeatedly described.

As shown in FIG. 3, the method of this embodiment of the present disclosure may specifically include the following steps.

S210: receiving, by a client, a data viewing request for a target table, and determining a first editing time corresponding to first table data to be requested to view, wherein the client stores second table data corresponding to the target table at a second editing time.

S220: when the first editing time is later than the second editing time, determining a data editing operation to alter the second table data to the first table data according to the first editing time and the second editing time, and obtaining table data associated with the data editing operation in the second table data as the data to be altered.

The data editing operation may be an operation of editing the table data. Specifically, the data editing operation includes edited table data and an editing manner of the edited table data. Optionally, the data editing operation includes at least one of operations performed on the edited table data, such as a data adding operation, a data deleting operation, a data modifying operation, and a data location moving operation. In an embodiment of the present disclosure, when the first editing time is later than the second editing time, the first table data can be obtained by inputting the editing operation for the second table data, and the operation performed for altering from the second table data to the first table data may be used as the data editing operation. The data to be altered may be the table data in the second table data on which the data editing operation acts. The data to be altered may include a plurality of pieces of data associated with the data editing operation. Optionally, the data to be altered includes at least table data to be altered and location data of the table data to be altered in the target table. The table data to be altered may be table data to be processed. The location data may be used for indicating the location of the table data to be altered in the target table. For example, the location data may be used for indicating which row and which column in the target table the table data to be altered is in, or indicating the display location in a visual window.

In an embodiment of the present disclosure, when the first editing time is later than the second editing time, the data editing operation performed on the target table between the first editing time and the second editing time can be determined according to the two times, and the determined data editing operation is used as the data editing operation performed to alter the second table data to the first table data. Further, the second table data can be analyzed according to the data editing operation, and the table data the data editing operation acts on is determined to serve as the table data to be altered, and the location data of the table data to be altered in the target table is determined. Further, the determined table data to be altered and the location data of the table data to be altered in the target table can be used as the data to be altered.

It needs to be noted that when multiple editions are performed on the target table at different times, in order to rapidly find the table data obtained after editing the target table at any historical time and the data editing operation performed on the target table at the historical time, after the table data obtained after editing the target table at the historical time is obtained, the table data and the editing time can be stored in association with an operation identifier for representing the corresponding data editing operation. Further, when there is a need to determine the data editing operation performed to alter the second table data to the first table data, an operation identifier corresponding to the first editing time and an operation identifier between the first editing time and the second editing time can be determined, and then the data editing operation performed can be determined according to the determined operation identifiers.

Optionally, determining, according to the first editing time and the second editing time, the data editing operation performed to alter the second table data to the first table data includes: determining a first data alteration identifier corresponding to the first editing time and a second data alteration identifier between the first editing time and the second editing time, and obtaining the data editing operation performed on table data corresponding to the first data alteration identifier and the second data alteration identifier. The advantages of doing so are as follows: the effect of effectively determining the data editing operation performed between the first editing time and the second editing time according to the two times is achieved; the data editing operation performed is determined according to the data alteration identifiers such that the convenience of the process of determining the data editing operation is enhanced, and thus, the creation efficiency of the table data to be requested to view is improved.

The first data alteration identifier may be used for representing the data editing operation performed on the target table at the first editing time. The first data alteration identifier may be information capable of representing any type of the data editing operation. Optionally, the first data alteration identifier is information constituted based on a number, a text, or other characters. The second data alteration identifier may be used for representing the data altering process of the target table between the first editing time and the second editing time. The number of the second data alteration identifiers may be one or more. In an embodiment of the present disclosure, altering from the second table data to the first table data may be done through at least one data alteration. Thus, when the data editing operation performed to alter the second table data to the first table data is determined, the data alteration identifier between the first editing time and the second editing time may be determined such that the data alteration process of altering from the second table data to the first table data is determined based on the data alteration process.

As an optional implementation of the embodiments of the present disclosure, after the target table is edited and the table data is obtained, the table data and the editing time may be stored in association with the data alteration identifier representing that the target table has been altered. Further, when the first editing time and the second editing time are determined, the first data alteration identifier corresponding to the first editing time and the second data alteration identifier between the first editing time and the second editing time may be determined according to a pre-created association relationship. Further, the data editing operation performed on the table data at the first editing time and the data editing operation performed on the table data at the first editing time and the second editing time may be determined according to the first data identifier, and the determined data editing operation is taken as the data editing operation performed to alter the second table data to the first table data.

S230: backing up the data to be altered, and displaying the first table data in the client according to the second table data and the backed-up data to be altered.

In an embodiment of the present disclosure, when the data editing operation performed to alter the second table data to the first table data has been determined, the first table data can be determined according to the data editing operation, the second table data, and the backed-up data to be altered, and displayed in the client.

Optionally, displaying, according to the second table data and the backed-up data to be altered, the first table data in the client includes: performing the data editing operation on the backed-up data to be altered to generate target altered data, and displaying the first table data in the client according to the second table data and the target altered data.

The target altered data may be the table data generated after performing the data editing operation on the backed-up data to be altered.

As an optional implementation of the embodiments of the present disclosure, the table data to be altered and the location data of the table data to be altered in the target table may be determined according to the backed-up data to be altered. Further, the data editing operation may be performed on the table data to be altered in accordance with the location data to generate the target altered data. Further, the first table data may be determined according to the target altered data and the second table data and displayed in the client. The advantages of doing so are as follows: by applying the data editing operation to the backed-up data to be altered to create the table data to be requested to view, the effect of applying the data editing operation to the stored and backed-up table data to display the table data to be requested to view is achieved; the response rate of the client in viewing different historically edited data is increased; and the processing performance of the client for the table data is improved.

Optionally, displaying, according to the second table data and the target altered data, the first table data in the client includes: determining unaltered table data other than the data to be altered in the second table data, and displaying, according to the unaltered table data and the target altered data, the first table data in the client.

The unaltered table data may be data associated with other table data than the table data to be altered in the second table data. Optionally, the unaltered table data includes at least table data not altered and location data of the table data not altered in the target table. Exemplarily, it is assumed that the second table data includes three data records, i.e., record A, record B, and record C, and the record B is the table data to be altered. Thus, the record A and the record C may be used as the table data not altered.

As an optional implementation of the present embodiment, the unaltered table data other than the data to be altered in the second table data may be determined based on the data to be altered, and the unaltered table data may include the table data not altered and the location data of the table data not altered in the target table. Further, the table data may be generated according to the unaltered table data in the data to be altered and the location data thereof in the target table, as well as the table data not altered in the unaltered table data and the location data thereof in the target table, and the generated table data may be used as the first table data. Thus, the first table data may be displayed in the client. The advantages of doing so are as follows: the effect of creating, based on the stored table data and the data editing operation, the table data to be requested to view is achieved; and the effect of increasing, on the basis of effectively saving the resource occupation space of the client, the response rate of the client in viewing different historically edited data is achieved.

Exemplarily, FIG. 4 is a schematic diagram of a table data displaying process provided by an embodiment of the present disclosure. As shown in FIG. 4, the table data stored in the historical record manager includes record A, record B, and record C. When the model layer requests to view the table data, the required table data may be pulled from the historical record manager. Further, when it is determined that the data to be altered is the record B according to the table data to be requested to view and the stored table data, the record B may be backed up, and the table data to be requested to view is created according to the backed-up record B (denoted by the solid box in FIG. 4) and the record A and the record C (denoted by the dotted boxes in FIG. 4) not altered.

According to the technical solutions of the embodiments of the present disclosure, when the first editing time is later than the second editing time, the data editing operation performed to alter the second table data to the first table data is determined according to the first editing time and the second editing time, and the table data associated with the data editing operation in the second table data is obtained as the data to be altered; accordingly, the effects of determining the data editing operation performed on the table data between the stored editing time and the editing time to be requested to view according to the two editing times and then determining the data to be altered based on the data editing operation are achieved; thus, the effect of using the stored table data as the data basis for creating the table data to be requested to view is achieved.

FIG. 5 is a flowchart of another table data processing method provided by an embodiment of the present disclosure. The technical solution of this embodiment of the present disclosure is based on the above embodiments. After determining the first editing time of the target table corresponding to the first table data to be requested to view, the method further includes: when the first editing time is earlier than the second editing time, pulling, from a server, third table data corresponding to the target table at the first editing time, and storing the third table data to the client; and displaying, based on the third table data stored by the client, the first table data corresponding to the data viewing request in the client. The specific implementation may be as described as in this embodiment of the present embodiment. The technical features identical or similar to those in the foregoing embodiments will not be repeatedly described. As shown in FIG. 5, the method of this embodiment of the present disclosure may specifically include the following steps.

S310: receiving a data viewing request for a target table by a client, and determining a first editing time corresponding to first table data to be requested to view, wherein the client stores second table data corresponding to the target table at a second editing time.

S320: pulling third table data corresponding to the target table at the first editing time from a server and storing the third table data to the client in response to the first editing time being earlier than the second editing time.

The third table data may be table data pulled by the client from the server and corresponding to the target table at the first editing time.

In an embodiment of the present disclosure, when the first editing time is earlier than the second editing time, it may indicate that when the target table is edited, the first table data edited at the first editing time may be obtained first and then the second table data edited at the second editing time is obtained. Thus, when the first table data is viewed, the specific content in the first table data cannot be determined through the second table data. Further, the table data corresponding to the target table at the first editing time may be pulled from the server, and the pulled table data is used as the third table data and stored in the client.

S330: displaying the first table data corresponding to the data viewing request in the client based on the third table data stored by the client.

In an embodiment of the present disclosure, when the client stores the third table data corresponding to the target table at the first editing time, the stored third table data may be used as the first table data corresponding to the data viewing request, and the first table data is displayed in the client.

S340: determining data to be altered corresponding to the data viewing request in the second table data according to the first editing time and the second editing time in response to the first editing time being later than the second editing time.

S350: backing up the data to be altered, and displaying the first table data in the client according to the second table data and the backed-up data to be altered.

According to the technical solutions of the embodiments of the present disclosure, after determining the first editing time of the target table corresponding to the first table data to be requested to view, when the first editing time is earlier than the second editing time, the third table data corresponding to the target table at the first editing time is pulled from the server, and stored to the client; and the first table data corresponding to the data viewing request is displayed in the client based on the third table data stored by the client. The effect of pulling the table data to be requested to view the client from the server in response to the editing time to be requested to view being earlier than the stored editing time is achieved. That is, the effects of pulling the targeted table data from the server and thus effectively saving the resource occupation space of the client are achieved.

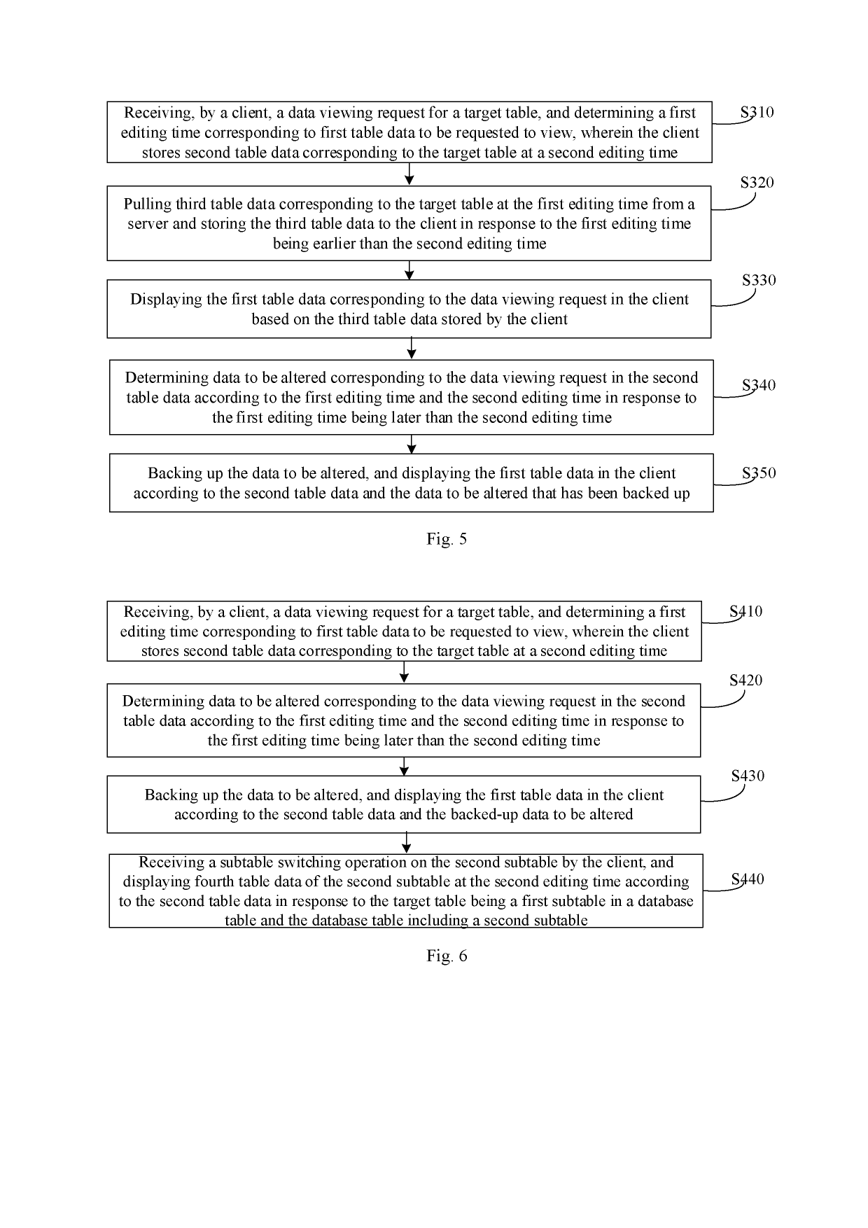

FIG. 6 is a flowchart of another table data processing method provided by an embodiment of the present disclosure. The technical solution of this embodiment of the present disclosure is based on the above embodiments. When the target table is a first subtable in a database table and the database table includes a second subtable, a subtable switching operation on the second subtable is received by the client, and fourth table data of the second subtable at the second editing time is displayed according to the second table data. The specific implementation may be as described as in this embodiment of the present embodiment. The technical features identical or similar to those in the foregoing embodiments will not be repeatedly described.

As shown in FIG. 6, the method of this embodiment of the present disclosure may specifically include the following steps.

S410: receiving a data viewing request for a target table by a client, and determining a first editing time corresponding to first table data to be requested to view, wherein the client stores second table data corresponding to the target table at a second editing time.

S420: determining data to be altered corresponding to the data viewing request in the second table data according to the first editing time and the second editing time in response to the first editing time being later than the second editing time.

S430: backing up the data to be altered, and displaying the first table data in the client according to the second table data and the backed-up data to be altered.

S440: receiving a subtable switching operation on the second subtable by the client, and displaying fourth table data of the second subtable at the second editing time according to the second table data in response to the target table being a first subtable in a database table and the database table including a second subtable.

The database table may include a plurality of subtables. A cross-table operation may also be performed among a plurality of subtables by means of a cross-table formula, a one-way or two-way associated field, searching for a reference field, etc. The second subtable may be other data table than the first subtable in the database table. Exemplarily, it is assumed that the database table includes 5 subtables: data table 1, data table 2, data table 3, data table 4, and data table 5. When the data table 2 is the first subtable, the data table 1, the data table 3, the data table 4, and the data table 5 are the second subtables. The subtable switching operation may be construed as an operation of switching a subtable displayed in the interface to other subtable. Optionally, the subtable switching operation includes, but is not limited to, at least one of a clicking operation (including a single click or multiple clicks), a long press operation, a touch operation, and a slide operation. The fourth table data may be table data obtained by editing the second subtable in the target table at the second editing time. It needs to be noted that a single subtable may also be the database table.

In an embodiment of the present disclosure, when the target table is the first subtable in the database table and the database table includes the second subtable, after the first table data corresponding to the target table is displayed by the client, in response to receiving the subtable switching operation on the second subtable by the client, the second editing time corresponding to the table data to be displayed by the second subtable can be determined according to the second table data corresponding to the target table that has been stored in the client. Further, the fourth table data corresponding to the second subtable at the second editing time may be determined, and displayed in the client.

It needs to be noted that there may be a plurality of ways of displaying the fourth table data according to the second table data. Optionally, the client may also store the fourth table data corresponding to the second subtable at the second editing time while storing the second table data corresponding to the target table at the second editing time. Alternatively, the second editing time is determined based on the second table data stored by the client, and the fourth table data corresponding to the second subtable at the second editing time is pulled from the server based on the second editing time and the second subtable.

As an optional implementation of the embodiments of the present disclosure, when the subtable switching operation on the second subtable is detected, the editing time of the table data corresponding to the second subtable to be displayed may be determined as the second editing time according to the second table data stored in the client. Further, the fourth table data corresponding to the second subtable at the second editing time may be pulled from the server based on the second editing time and the second subtable, stored in the client, and displayed in the client.

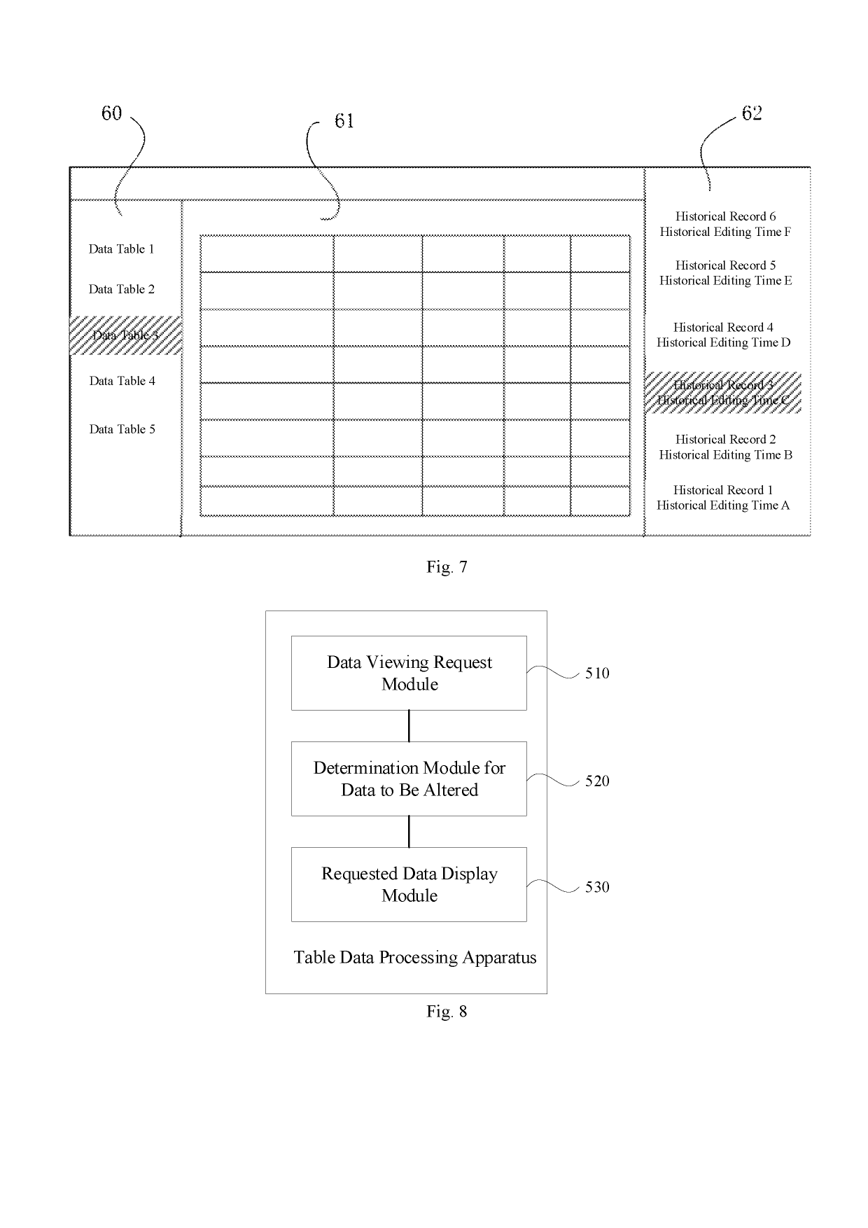

Exemplarily, FIG. 7 is a schematic diagram of an interface for displaying a database table provided by an embodiment of the present disclosure. As shown in FIG. 7, the display interface includes a data table switching region 60, a data table display region 61, and a historical record display region 62. Data table 1, data table 2, data table 3, data table 4, and data table 5 are displayed in the data table switching region. Historical record 1, historical record 2, historical record 3, historical record 4, historical record 5, and historical record 6 are displayed in the historical record display region. The historical record 1 corresponds to historical editing time A, the historical record 2 corresponds to historical editing time B, the historical record 3 corresponds to historical editing time C, the historical record 4 corresponds to historical editing time D, the historical record 5 corresponds to historical editing time E, and the historical record 6 corresponds to historical editing time F. Moreover, the six historical editing times are in the following order: the historical editing time A, the historical editing time B, the historical editing time C, the historical editing time D, the historical editing time E, and the historical editing time F, and the historical editing time A is the earliest, and the historical editing time F is the latest. The table data corresponding to the respective data tables at the respective historical editing times can be displayed based on the data table display region. If the client stores the table data corresponding to the data table 2 at the historical editing time C, after the table data corresponding to the data table 3 at the historical editing time D is displayed in the data table display region, when the subtable switching operation on the data table 2 is detected, the editing time of the table data corresponding to the data table 2 to be displayed may be determined as the historical editing time C according to the table data corresponding to the data table 2 stored in the client at the historical editing time C. Further, the table data corresponding to the data table 2 at the historical editing time C may be pulled from the server, and displayed in the data table display region, and the historical record 3 corresponding to the historical editing time C is highlighted among a plurality of historical records in the historical record display region.

According to the technical solutions of the embodiments of the present disclosure, after the second table data or the first table data of the target table at the second editing time is shown in the client, when the target table is the first subtable in the database table and the database table includes the second subtable, the subtable switching operation on the second subtable is received by the client, and the fourth table data of the second subtable at the second editing time is displayed according to the second table data. The effect of displaying the subtables in the database table independent of one another is achieved. That is, the effect that the other subtables will not be affected by the alteration of the table data displayed by any subtable is achieved.

FIG. 8 is a structural schematic diagram of a table data processing apparatus provided by an embodiment of the present disclosure. As shown in FIG. 8, the apparatus includes a data viewing request module 510, a determination module for data to be altered 520, and a requested data display module 530. The data viewing request module 510 is configured to receive, by a client, a data viewing request for a target table, and determine a first editing time corresponding to first table data to be requested to view, wherein the client stores second table data corresponding to the target table at a second editing time. The determination module for data to be altered 520 is configured to, when the first editing time is later than the second editing time, determine, according to the first editing time and the second editing time, data to be altered corresponding to the data viewing request in the second table data. The requested data display module 530 is configured to back up the data to be altered, and display, according to the second table data and the backed-up data to be altered, the first table data in the client.

According to the technical solutions of the embodiments of the present disclosure, the data viewing request for the target table is received by the client, and the first editing time corresponding to the first table data to be requested to view is determined. By means of interactive operations between the user and the client, viewing of the table data can be triggered and the subsequent operation determined for the table data can be performed. The client stores the second table data corresponding to the target table at the second editing time. The effects of storing at least part of table data corresponding to the target table is stored in the client and using the stored table data as data basis of the subsequent operation are achieved. Further, when the first editing time is later than the second editing time, the data to be altered corresponding to the data viewing request in the second table data is determined according to the first editing time and the second editing time. The effect of using the stored table data as data creation basis of the table data to be requested to view when the editing time to be requested to view is later than the stored editing time is achieved. Further, the data to be altered is backed up, and the first table data is displayed in the client according to the second table data and the backed-up data to be altered. The problems of the table data processing way in the related art, i.e., occupying a lot of resource storage space of the client and bringing great pressure for the internal memory of the client which in turns lead to slow response of the client to the table viewing request, are solved. By backing up the data to be altered in the stored table data to create the table data to be requested to view, the effect of creating the table data to be requested to view in accordance with the stored table data is achieved. Thus, the effect of effectively saving the resource occupation space of the client on the basis of ensuring that the modified stored data does not affect the cache of the client is achieved. Thus, the response rate of viewing the table data by the client is increased, and the processing performance of the client for the table data is improved.

On the basis of any optional technical solution of the embodiments of the present disclosure, optionally, the determination module for data to be altered 520 is specifically configured to determine, according to the first editing time and the second editing time, a data editing operation performed to alter the second table data to the first table data, and obtain table data associated with the data editing operation in the second table data as the data to be altered.

On the basis of any optional technical solution of the embodiments of the present disclosure, optionally, the determination module for data to be altered 520 includes a data editing operation obtaining unit. The data editing operation obtaining unit is configured to determine a first data alteration identifier corresponding to the first editing time and a second data alteration identifier between the first editing time and the second editing time, and obtain the data editing operation performed on table data corresponding to the first data alteration identifier and the second data alteration identifier.

On the basis of any optional technical solution of the embodiments of the present disclosure, optionally, the data to be altered includes at least table data to be altered and location data of the table data to be altered in the target table.

On the basis of any optional technical solution of the embodiments of the present disclosure, optionally, the requested data display module 530 includes a table data display unit. The table data display unit is configured to perform the data editing operation on the backed-up data to be altered to generate target altered data, and display, according to the second table data and the target altered data, the first table data in the client.

On the basis of any optional technical solution of the embodiments of the present disclosure, optionally, the table data display unit is specifically configured to determine unaltered table data other than the data to be altered in the second table data, and display, according to the unaltered table data and the target altered data, the first table data in the client.

On the basis of any optional technical solution of the embodiments of the present disclosure, optionally, the apparatus further includes a data pulling module and a table data display module. The data pulling module is configured to, after determining the first editing time of the target table corresponding to the first table data to be requested to view, when the first editing time is earlier than the second editing time, pull, from a server, third table data corresponding to the target table at the first editing time, and store the third table data to the client. The table data display module is configured to display, based on the third table data stored by the client, the first table data corresponding to the data viewing request in the client.

On the basis of any optional technical solution of the embodiments of the present disclosure, optionally, the apparatus further includes a subtable switching module. The subtable switching module is configured to, after the second table data or the first table data of the target table at the second editing time is shown in the client, when the target table is a first subtable in a database table and the database table includes a second subtable, receive, by the client, a subtable switching operation on the second subtable, and display, according to the second table data, fourth table data of the second subtable at the second editing time.

On the basis of any optional technical solution of the embodiments of the present disclosure, optionally, the apparatus further includes a data highlighting module. The data highlighting module is configured to, after displaying, according to the second table data and the backed-up data to be altered, the first table data in the client, highlight, in the first table data, target table data generated by editing the target table at the first editing time.

The table data processing apparatus provided by the embodiment of the present disclosure may perform the table data processing method provided by any embodiment of the present disclosure and has corresponding functional modules for performing the table data processing method and corresponding beneficial effects.

It needs to be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

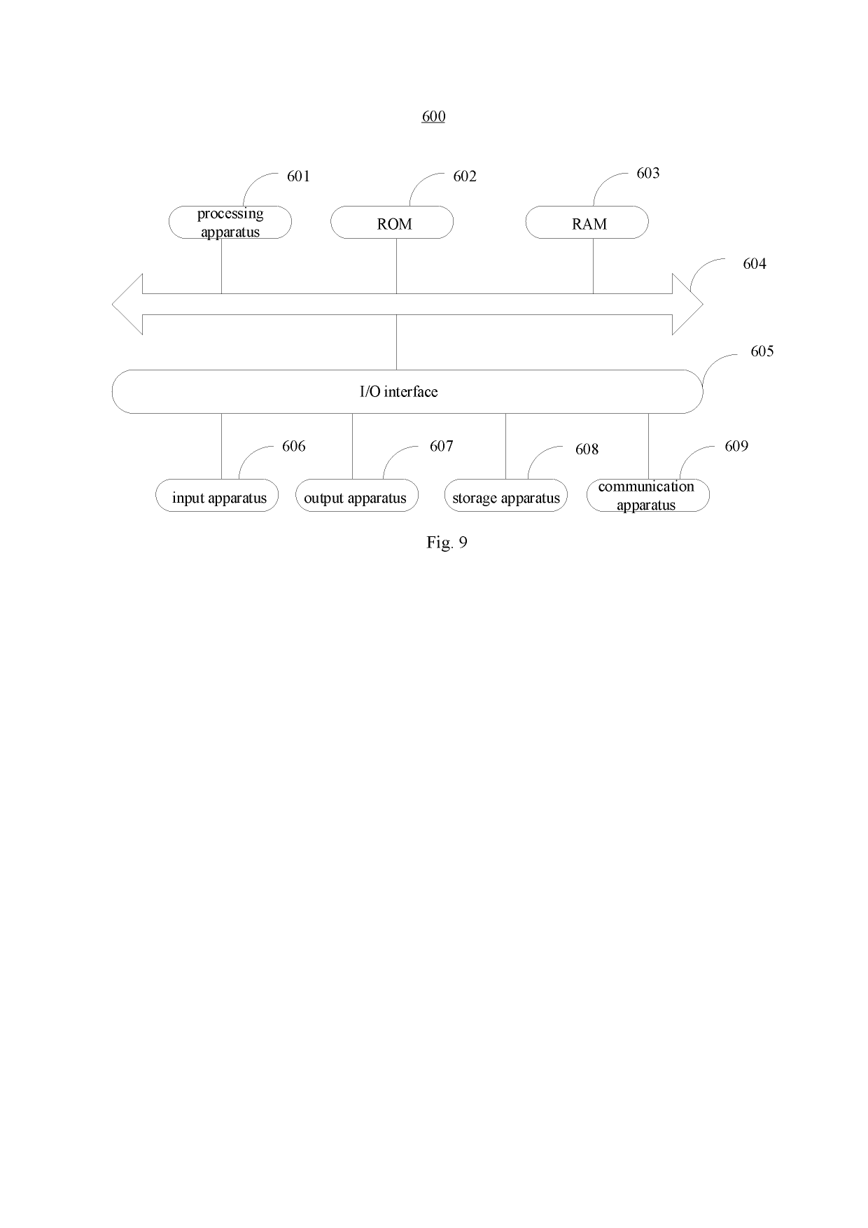

FIG. 9 illustrates a schematic structural diagram of an electronic device 600 provided by an embodiment of the present disclosure. Referring to FIG. 9, FIG. 9 illustrates a schematic structural diagram of an electronic device 600 suitable for implementing some embodiments of the present disclosure. The electronic device 600 in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603 to perform various actions and processing to realize the environmental camera configuration method provided by the embodiment of the present disclosure. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 3 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

Names of messages or information exchanged between a plurality of apparatuses in embodiments of the present disclosure are only used for the purpose of description and not meant to limit the scope of these messages or information.

The electronic device provided by this embodiment of the present disclosure and the table data processing method provided by the foregoing embodiments belong to the same inventive concept. For technical details not described in detail in this embodiment of the present disclosure, reference may be made to the foregoing embodiments, and this embodiment of the present disclosure and the foregoing embodiments have the same beneficial effects.

An embodiment of the present disclosure provides a non-transitory computer storage medium storing a computer program which, when executed by a processor, implements the table data processing method provided by the foregoing embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, Example 1 provides a table data processing method comprising: receiving, by a client, a data viewing request for a target table, and determining a first editing time corresponding to first table data to be requested to view, wherein the client stores second table data corresponding to the target table at a second editing time; determining, according to the first editing time and the second editing time, data to be altered corresponding to the data viewing request in the second table data in response to the first editing time being later than the second editing time; and backing up the data to be altered, and displaying the first table data in the client according to the second table data and the data to be altered that has been backed up.

According to one or more embodiments of the present disclosure, Example 2 provides the method provide by Example 1, and further comprises: optionally, the determining, according to the first editing time and the second editing time, data to be altered in the second table data comprising: determining a data editing operation to alter the second table data to the first table data according to the first editing time and the second editing time, and obtaining table data associated with the data editing operation in the second table data as the data to be altered.

According to one or more embodiments of the present disclosure, Example 3 provides the method provide by Example 2, and further comprises: optionally, the determining a data editing operation to alter the second table data to the first table data according to the first editing time and the second editing time comprising: determining a first data alteration identifier corresponding to the first editing time and a second data alteration identifier between the first editing time and the second editing time, and obtaining the data editing operation performed on table data corresponding to the first data alteration identifier and the second data alteration identifier.

According to one or more embodiments of the present disclosure, Example 4 provides the method provide by Example 2, and further comprises: optionally, the data to be altered comprising at least table data to be altered and location data of the table data to be altered in the target table.

According to one or more embodiments of the present disclosure, Example 5 provides the method provide by Example 2, and further comprises: optionally, the displaying the first table data in the client according to the second table data and the data to be altered that has been backed up comprising: performing the data editing operation on the data to be altered that has been backed up to generate target altered data, and displaying the first table data in the client according to the second table data and the target altered data.

According to one or more embodiments of the present disclosure, Example 6 provides the method provide by Example 5, and further comprises: optionally, the displaying the first table data in the client according to the second table data and the target altered data comprising: determining unaltered table data other than the data to be altered in the second table data, and displaying the first table data in the client according to the unaltered table data and the target altered data.

According to one or more embodiments of the present disclosure, Example 7 provides the method provide by Example 1, and further comprises: optionally, after determining the first editing time of the target table corresponding to the first table data to be requested to view, the method further comprising: pulling, from a server, third table data corresponding to the target table at the first editing time and storing the third table data to the client in response to the first editing time being earlier than the second editing time; and displaying, based on the third table data stored by the client, the first table data corresponding to the data viewing request in the client.

According to one or more embodiments of the present disclosure, Example 8 provides the method provide by Example 1, and further comprises: optionally, the method further comprising: after displaying the second table data or the first table data of the target table at the second editing time in the client, in response to the target table being a first subtable in a database table and the database table comprising a second subtable, receiving, by the client, a subtable switching operation on the second subtable, and displaying, according to the second table data, fourth table data of the second subtable at the second editing time.

According to one or more embodiments of the present disclosure, Example 9 provides the method provide by Example 1, and further comprises: optionally, after displaying the first table data in the client according to the second table data and the data to be altered that has been backed up, the method further comprising: highlighting, in the first table data, target table data generated by editing the target table at the first editing time.

According to one or more embodiments of the present disclosure, Example 10 provides a table data processing apparatus, comprising: a data viewing request module configured to receive, by a client, a data viewing request for a target table, and determine a first editing time corresponding to first table data to be requested to view, wherein the client stores second table data corresponding to the target table at a second editing time; a determination module for data to be altered configured to, determine, according to the first editing time and the second editing time, data to be altered corresponding to the data viewing request in the second table data in response to the first editing time being later than the second editing time; and a requested data display module configured to back up the data to be altered, and display, according to the second table data and the backed-up data to be altered, the first table data in the client.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: receive, by a client, a data viewing request for a target table, and determine a first editing time corresponding to first table data to be requested to view, wherein the client stores second table data corresponding to the target table at a second editing time; determine, according to the first editing time and the second editing time, data to be altered corresponding to the data viewing request in the second table data in response to the first editing time being later than the second editing time; and back up the data to be altered, and displaying the first table data in the client according to the second table data and the data to be altered that has been backed up.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A table data processing method, comprising:
receiving, by a client, a data viewing request for a target table, and determining a first editing time corresponding to first table data to be requested to view, wherein the client stores second table data corresponding to the target table at a second editing time;
determining, according to the first editing time and the second editing time, data to be altered corresponding to the data viewing request in the second table data in response to the first editing time being later than the second editing time; and
backing up the data to be altered, and displaying the first table data in the client according to the second table data and the data to be altered that has been backed up.

2. The table data processing method according to claim 1, wherein the determining, according to the first editing time and the second editing time, data to be altered in the second table data comprises:
determining a data editing operation to alter the second table data to the first table data according to the first editing time and the second editing time, and obtaining table data associated with the data editing operation in the second table data as the data to be altered.

3. The table data processing method according to claim 2, wherein the determining a data editing operation to alter the second table data to the first table data according to the first editing time and the second editing time comprises:
determining a first data alteration identifier corresponding to the first editing time and a second data alteration identifier between the first editing time and the second editing time, and obtaining the data editing operation performed on table data corresponding to the first data alteration identifier and the second data alteration identifier.

4. The table data processing method according to claim 2, wherein the data to be altered comprises at least table data to be altered and location data of the table data to be altered in the target table.

5. The table data processing method according to claim 2, wherein the displaying the first table data in the client according to the second table data and the data to be altered that has been backed up comprises:
performing the data editing operation on the data to be altered that has been backed up to generate target altered data, and displaying the first table data in the client according to the second table data and the target altered data.

6. The table data processing method according to claim 5, wherein the displaying the first table data in the client according to the second table data and the target altered data comprises:
determining unaltered table data other than the data to be altered in the second table data, and displaying the first table data in the client according to the unaltered table data and the target altered data.

7. The table data processing method according to claim 1, after determining the first editing time of the target table corresponding to the first table data to be requested to view, further comprising:
pulling, from a server, third table data corresponding to the target table at the first editing time and storing the third table data to the client in response to the first editing time being earlier than the second editing time; and
displaying, based on the third table data stored by the client, the first table data corresponding to the data viewing request in the client.

8. The table data processing method according to claim 1, further comprising:
after displaying the second table data or the first table data of the target table at the second editing time in the client,
in response to the target table being a first subtable in a database table and the database table comprising a second subtable, receiving, by the client, a subtable switching operation on the second subtable, and displaying, according to the second table data, fourth table data of the second subtable at the second editing time.

9. The table data processing method according to claim 1, after displaying the first table data in the client according to the second table data and the data to be altered that has been backed up, further comprising:
highlighting, in the first table data, target table data generated by editing the target table at the first editing time.

10. An electronic device, comprising:
one or more processors; and
a storage apparatus configured to store one or more programs,
wherein the one or more programs, when executed by the one or more processors, cause the one or more processors to implement a table data processing method comprising:
receiving, by a client, a data viewing request for a target table, and determining a first editing time corresponding to first table data to be requested to view, wherein the client stores second table data corresponding to the target table at a second editing time;
determining, according to the first editing time and the second editing time, data to be altered corresponding to the data viewing request in the second table data in response to the first editing time being later than the second editing time; and
backing up the data to be altered, and displaying the first table data in the client according to the second table data and the data to be altered that has been backed up.

11. The electronic device according to claim 10, wherein the determining, according to the first editing time and the second editing time, data to be altered in the second table data comprises:
determining a data editing operation to alter the second table data to the first table data according to the first editing time and the second editing time, and obtaining table data associated with the data editing operation in the second table data as the data to be altered.

12. The electronic device according to claim 11, wherein the determining a data editing operation to alter the second table data to the first table data according to the first editing time and the second editing time comprises:
determining a first data alteration identifier corresponding to the first editing time and a second data alteration identifier between the first editing time and the second editing time, and obtaining the data editing operation performed on table data corresponding to the first data alteration identifier and the second data alteration identifier.

13. The electronic device according to claim 11, wherein the data to be altered comprises at least table data to be altered and location data of the table data to be altered in the target table.

14. The table data processing method according to claim 11, wherein the displaying the first table data in the client according to the second table data and the data to be altered that has been backed up comprises:
performing the data editing operation on the data to be altered that has been backed up to generate target altered data, and displaying the first table data in the client according to the second table data and the target altered data.

15. The electronic device according to claim 14, wherein the displaying the first table data in the client according to the second table data and the target altered data comprises:
determining unaltered table data other than the data to be altered in the second table data, and displaying the first table data in the client according to the unaltered table data and the target altered data.

16. The electronic device according to claim 10, wherein after determining the first editing time of the target table corresponding to the first table data to be requested to view, the method further comprises:
pulling, from a server, third table data corresponding to the target table at the first editing time and storing the third table data to the client in response to the first editing time being earlier than the second editing time; and
displaying, based on the third table data stored by the client, the first table data corresponding to the data viewing request in the client.

17. The electronic device according to claim 10, wherein the method further comprises:
after displaying the second table data or the first table data of the target table at the second editing time in the client,
in response to the target table being a first subtable in a database table and the database table comprising a second subtable, receiving, by the client, a subtable switching operation on the second subtable, and displaying, according to the second table data, fourth table data of the second subtable at the second editing time.

18. The electronic device according to claim 10, wherein after displaying the first table data in the client according to the second table data and the data to be altered that has been backed up, the method further comprises:
highlighting, in the first table data, target table data generated by editing the target table at the first editing time.

19. A non-transitory storage medium comprising computer-executable instructions, wherein the computer-executable instructions, when executed by a computer processor, are configured to perform a table data processing method comprising:
receiving, by a client, a data viewing request for a target table, and determining a first editing time corresponding to first table data to be requested to view, wherein the client stores second table data corresponding to the target table at a second editing time;
determining, according to the first editing time and the second editing time, data to be altered corresponding to the data viewing request in the second table data in response to the first editing time being later than the second editing time; and
backing up the data to be altered, and displaying the first table data in the client according to the second table data and the data to be altered that has been backed up.
